(19) United States
(12) Patent Application Publication
(10) Pub. No.: US 2023/0112096 A1
(43) Pub. Date: Apr. 13, 2023

(54) DIVERSE CLUSTERING OF A DATA SET

(71) Applicant: SPARKCOGNITION, INC., Austin, TX (US)

(72) Inventors: JUNHWAN CHOI, AUSTIN, TX (US); TYLER McDONNELL, CANYON LAKE, TX (US); YIYUN LAN, SAN FRANCISCO, CA (US); KEITH D. MOORE, LEANDER, TX (US); CHUNG-YU HO, AUSTIN, TX (US)

(21) Appl. No.: 17/500,343

(22) Filed: Oct. 13, 2021

(51) Int. Cl. G06F 16/28

(52) U.S. Cl. CPC G06F 16/285

(57) ABSTRACT

Diverse clustering of a data set, including: generating a first plurality of clustering models based on a same data set; selecting, based on a novelty search of the first plurality of clustering models, a second plurality of clustering models; and generating a report based on the second plurality of clustering models.

### BACKGROUND

Clustering allows for a data set to be grouped such that the data points in a same group are similar according to some criteria. A generated clustering model (e.g., a result of applying a clustering algorithm to a data set) is dependent on a variety of factors, such as the particular clustering algorithm applied, the distance measurements used in the clustering algorithm, a feature selection for the clustering algorithm, and other factors. In other words, many different clustering models may be generated from a same data set depending on these factors. As clustering is an unsupervised machine learning approach, there is no ground truth in order to determine whether a given clustering model (e.g., a result of applying a clustering algorithm to a data set) is more correct or quantitatively better than another clustering model.

### BRIEF DESCRIPTION OF THE DRAWINGS

FIG. 1 is a block diagram of an example computer for diverse clustering of a data set according to some embodiments.

FIG. 2 is an example user interface for diverse clustering of a data set according to some embodiments.

FIG. 3 is an example user interface for diverse clustering of a data set according to some embodiments.

FIG. 4 is an example user interface for diverse clustering of a data set according to some embodiments.

FIG. 5 is an example user interface for diverse clustering of a data set according to some embodiments.

FIG. 6A is an example user interface for diverse clustering of a data set according to some embodiments.

FIG. 6B is an example user interface for diverse clustering of a data set according to some embodiments.

FIG. 6C is an example user interface for diverse clustering of a data set according to some embodiments.

FIG. 6D is an example user interface for diverse clustering of a data set according to some embodiments.

FIG. 7 is a flowchart of an example method for diverse clustering of a data set according to some embodiments.

FIG. 8 is a flowchart of another example method for diverse clustering of a data set according to some embodiments.

FIG. 9 is a flowchart of another example method for diverse clustering of a data set according to some embodiments.

FIG. 10 is a flowchart of another example method for diverse clustering of a data set according to some embodiments.

FIG. 11 is a flowchart of another example method for diverse clustering of a data set according to some embodiments.

FIG. 12 is a flowchart of another example method for diverse clustering of a data set according to some embodiments.

### DETAILED DESCRIPTION

Clustering allows for a data set to be grouped such that the data points in a same group are similar according to some criteria. A generated clustering model (e.g., a result of applying a clustering algorithm to a data set) is dependent on a variety of factors, such as the particular clustering algorithm applied, the distance measurements used in the clustering algorithm, a feature selection for the clustering algorithm, and other factors. In other words, many different clustering models may be generated from a same data set depending on these factors. As clustering is an unsupervised machine learning approach, there is no ground truth in order to determine whether a given clustering model (e.g., a result of applying a clustering algorithm to a data set) is more correct or quantitatively better than another clustering model. Different clustering models of the same data set may provide different perspectives on the data set that are each relevant to a user. In some cases, the perspectives provided by clustering model X may be more pertinent to a user N but the perspectives provided by a different clustering model Y may be more pertinent to a user M. Thus, there may not be an ideal or one-size-fits-all clustering model for a given set of data.

For example, assume a data set of customer data for a retailer. Each entry in the data set may describe a particular customer age, location, income level, annual spending with the retailer, and the like. Various clustering models of the data set may be generated. For example, one clustering model may group the customers into groups by age ranges, another clustering model may group the customers into ranges of annual spending, while another clustering model groups the customers by both age and income level. Each clustering model provides different insights into the groups of customers of that retailer, with no particular clustering model being more “correct” than another by any criteria.

To address these concerns, diverse clustering allows for different clustering models to be generated from a same data set. For example, each clustering model may be generated (e.g., trained) with different combinations of clustering algorithms and hyperparameters. A hyperparameter is an input parameter of a clustering algorithm whose value is used to control the classification process (e.g., the K value of a K-means algorithm), in contrast to a parameter that is derived through the execution of the algorithm itself. A novelty search may be performed on the generated clustering model to find a subset of novel clustering models that are diverse so as to provide different perspectives on the data set. A novelty search of clustering models is a selection of N clustering models (e.g., the second plurality of clustering models) as a subset of M clustering models (e.g., the first plurality of clustering models), where the selection is based on a degree of difference between the M clustering models. A report is then generated based on the novel clustering models. For example, the report may include a user interface including one or more visualizations for the novel clustering models. A user interacting with the user interface may select particular clustering models, clusters, or data points to explore various attributes of the selected item.

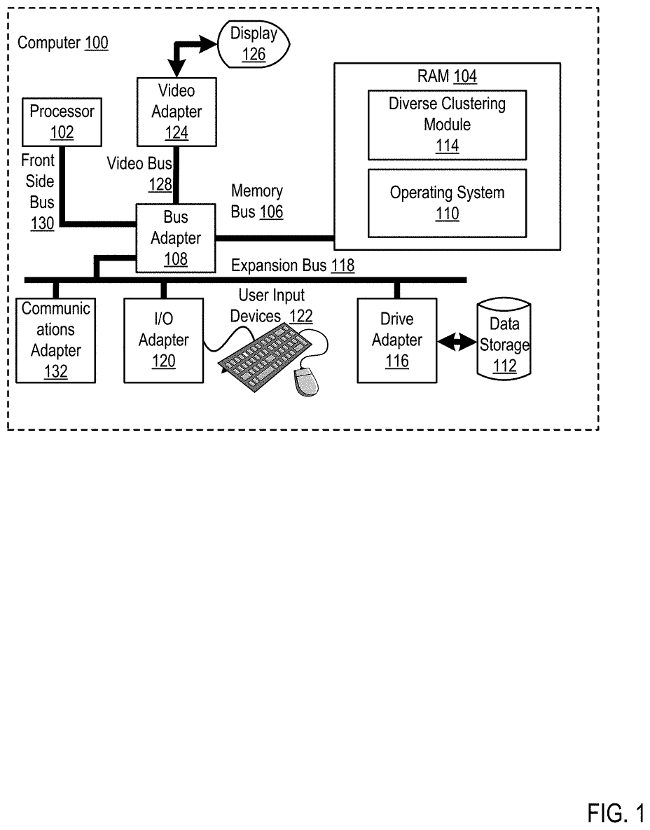

FIG. 1 is a block diagram of an exemplary computer 100 configured for diverse clustering of a data set according to certain embodiments. The computer 100 of FIG. 1 includes at least one computer processor 102 or ‘CPU’ as well as random access memory 104 (RAM′) which is connected through a high speed memory bus 106 and bus adapter 108 to processor 102 and to other components of the computer 100.

Stored in RAM 104 is an operating system 110. Operating systems useful in computers configured for diverse clustering of a data set according to certain embodiments include UNIX™, Linux™, Microsoft Windows™, and others as will occur to those of skill in the art. The operating system 110 in the example of FIG. 1 is shown in RAM 104, but many components of such software typically are stored in non-volatile memory also, such as, for example, on data storage 112, such as a disk drive. Also stored in RAM is the diverse clustering module 114 a module for diverse clustering of a data set according to certain embodiments.

The diverse clustering module 114 generates a first plurality of clustering models based on a data set. Each entry in the data set includes one or more values for one or more attributes (e.g., “features”). For example, where the data set is expressed as a table, each entry may correspond to a row while each feature may correspond to a column. Each clustering model of the first plurality of clustering models is a result of applying a given clustering algorithm to the data set using a particular set of hyperparameters. Thus, each of the first plurality of clustering models is different by virtue of being generated based on a different combination of an algorithm and hyperparameters relative to another clustering model. For example, two clustering models using the same clustering algorithm but different hyperparameter values would be considered different, two clustering models using different clustering algorithms but the same hyperparameter values would be considered different, and two clustering models using different clustering algorithms and hyperparameter values would also be considered different.

One skilled in the art will appreciate that the approaches described herein may be applied to any applicable clustering algorithm, including Hierarchical Density-Based Spatial Clustering of Applications with Noise (HDBSCAN), SpectralNet, and the like. The hyperparameters of the clustering algorithm describe various configurable attributes used by a given clustering algorithm independent of the actual values of the data set. For example, the hyperparameters may include a minimum number of clusters to be generated, a maximum number of clusters to be generated, or a specific number of clusters to be generated. In some embodiments, the number of clusters to be generated based on a list or range of numbers. For example, assuming the number of clusters to be generated is based on a list. In such an embodiment, each clustering algorithm may be applied to each permutation of hyperparameter values including each number in the list.

In some embodiments, the number of clusters to be generated (e.g., minimum, maximum, specific, or list) is defined based on a user input. In other embodiments, the number of clusters to be generated is dynamically calculated. For example, an algorithm to determine a best number of clusters may be applied to the data set, and the determined number is used as the number of clusters to be generated. As another example, the determined number may be used to generate a list of numbers of clusters. Continuing this example, for a determined number of clusters n_clusters, the list may be generated as [n_clusters/2, n_clusters, n_clusters*2], or by another approach as can be appreciated.

In some embodiments, the hyperparameters may include a distance measure to be used by the clustering algorithm. A distance measure is an algorithm or function to determine the distance between two points (e.g., entries) in the data set. For example, the distance measure may include a Euclidian distance function, a Manhattan distance function, a correlation distance function, or other distance function as can be appreciated. One skilled in the art will appreciate that the resulting clustering models generated from the same data set may vary based on the particular distance function used to generate the clusters of the clustering model.

In some embodiments, the hyperparameters may include a feature selection of the data set. A feature selection is a set of particular features of the data set to be used when generating the clustering model. Thus, a for a given feature selection that excludes one or more features of the data set, the excluded one or more features will not be considered when generating the clustering model. In some embodiments, the plurality of first clustering models may be generated using each possible combination of selected features. In some embodiments, the first plurality of clustering models may be generated such that each feature set combination used in generating the first plurality of clustering models always includes a particular feature. For example, given the retail customer example above, a user may specify that income range should always be included in any feature selection for which a clustering model is generated. In some embodiments, the first plurality of clustering models may be generated such that each feature set combination used in generating the first plurality of clustering models always excludes a particular feature. For example, given the retail customer example above, a user may specify that age should always be excluded in any feature selection for which a clustering model is generated. In some embodiments, the hyperparameters include whether or not principal component analysis (PCA) is applied to the data set prior to applying the clustering algorithm. By applying PCA, a subset of the features of the data set may be selected for application of the clustering algorithm.

The diverse clustering module 114 then selects, from the first plurality of clustering models, based on a novelty search of the first plurality of clustering models, a second plurality of clustering models. A novelty search of clustering models is a selection of N clustering models (e.g., the second plurality of clustering models) as a subset of M clustering models (e.g., the first plurality of clustering models), where the selection is based on a degree of difference between the M clustering models.

The novelty search may be performed using various metrics. The particular usage of such metrics and the particular clustering models upon which the measures will be calculated will be described in further detail below. In some embodiments, the metrics include a Rand index that quantitatively measures the similarity between two clustering models. In some embodiments, the metrics include a feature importance vector. A feature importance is quantitative measurement of the significance of a particular data set feature in generating a particular classification by a classifier model. Accordingly, a feature importance vector is a vector of feature importance values for each feature in the feature selection for the clustering model.

In some embodiments, calculating a feature importance vector for a given clustering model includes training a Random Forest classifier with the input data used to generate the clustering model (e.g., the selected feature data) and the clustering labels for the clustering model. The feature importance values for each feature in the selected feature is then calculated based on the Random Forest classifier. The resulting feature importance values are then included in the feature importance vector for the clustering model.

In some embodiments, the metrics include a novelty score. The novelty score is a quantitative evaluation of novelty between two clustering models. The novelty score for a pair of clustering models is based on the Rand index for the two clustering models and the feature importance vectors of each of the two clustering models. For example, in some embodiments, the novelty score NS may be calculated as NS=alpha*RI+cosine-similarity (FI1, FI2), where alpha is a free parameter, RI is the Rand index of the two clustering models, FI1 is the feature importance vector of a first clustering model, and FI2 is the feature importance vector of the second clustering model.

In some embodiments, the metrics include one or more cluster quality measurements. The cluster quality measurements for a given clustering model are quantitative evaluations of a degree of separation for clusters in the given clustering model, a degree of compactness for clusters in the given clustering model, or both. For example, in some embodiments, the cluster quality metrics include a Calinski-Harabasz score, a Silhouette score, or a Davies-Bouldin score. In other words, the one or more cluster quality metrics evaluate the topology of a given clustering model.

In some embodiments, prior to selecting the second plurality of clustering models from the first plurality of clustering models, the first plurality of clustering models are filtered based on the one or more cluster quality measurements. For example, clustering models having a particular cluster quality measurement above or below a threshold may be excluded from the first plurality of clustering models. As an example, clustering models with a Silhouette score below 0 may be filtered or removed from the first plurality of clustering models. This step removes noisy or unbalanced clustering models from consideration for inclusion in the second plurality of clustering models.

In some embodiments, selecting the second plurality of clustering models comprises selecting the second plurality of clustering models based on a clustering of a plurality of feature importance vectors corresponding to the first plurality of clustering models. For example, a feature importance vector is calculated for each of the first plurality of clustering models. A KMeans algorithm is then applied to the feature importance vectors, where k=N (e.g., the number of clustering models to be included in the second plurality of clustering models). This results in N clusters of feature importance vectors. For each of the N feature importance vector clusters, a corresponding clustering model with highest a Calinski-Harabasz (or other cluster quality measurement) score is included in the second plurality of clustering models. Thus, the second plurality of clustering models includes a clustering model with a highest Calinski-Harabasz score relative to other clustering models in a same feature importance vector cluster.

In some embodiments, selecting the second plurality of clustering models comprises selecting the second plurality of clustering models based on a plurality of novelty scores for a subset of the first plurality of clustering models. For example, in some embodiments, a Calinski-Harabasz (or other cluster quality measurement) score is calculated for each cluster model in the first plurality of clustering models, because these cluster quality measurements measure topological differences between clustering results. Where N is the number of clustering models to be included in the second plurality of clustering models, k clustering models are selected for inclusion in the second plurality of clustering models based on the ranking of the Calinski-Harabasz scores, where k=N/2. For example, clustering models at index (0, M/k, 2*M/k, . . . ) are added to the second plurality of clustering models, where M is the number of clustering models in the first plurality of clustering models.

For each of these selected clustering models (e.g., selected based on the Calinski-Harabasz scores), a novelty score is calculated relative to every other clustering model in the first plurality of clustering model (e.g., unselected clustering models). Thus, each novelty score is calculated relative to a selected clustering model and an unselected clustering model. For the top N/2 novelty scores, the corresponding unselected clustering model is then added to the second plurality of clustering models. Thus the second plurality of clustering models includes N/2 clustering models selected based on a Calinski-Harabasz score and another N/2 clustering models selected based on novelty scores.

In some embodiments, selecting the second plurality of clustering models comprises selecting the second plurality of clustering models based on a clustering of a plurality of feature importance vectors corresponding to the first plurality of clustering models and a plurality of novelty scores for a subset of the first plurality of clustering models. As an example, in some embodiments, a feature importance vector is calculated for each of the first plurality of clustering models. A KMeans algorithm is then applied to the feature importance vectors, where k=N/2. This results in N/2 clusters of feature importance vectors. For each of the N/2 feature importance vector clusters, a corresponding clustering model with highest a Calinski-Harabasz (or other cluster quality measurement) score is selected for inclusion in the second plurality of clustering models.

For each of these selected clustering models (e.g., selected based on the feature importance vectors), a novelty score is calculated relative to every other clustering model in the first plurality of clustering model (e.g., unselected clustering models). Thus, each novelty score is calculated relative to a selected clustering model and an unselected clustering model. For the top N/2 novelty scores, the corresponding unselected clustering model is then added to the second plurality of clustering models. Thus the second plurality of clustering models includes N/2 clustering models selected based on feature importance vectors and another N/2 clustering models selected based on novelty scores.

In other embodiments, after running the KMeans (k=N/2) on the feature importance vectors, for a given feature importance vector cluster, a clustering model corresponding to a highest Calinski-Harabasz scoring feature importance vector is added to a list novelty_model_list. Novelty scores are then used to select a most novel clustering model from novelty_model_list using the geometric mean of the novelty distance. The selected clustering model is then added to a list novel_model_list. The process of selecting a most novel clustering model from novelty_model_list and adding it to novel_model_list is repeated until a size of the novel_model_list reaches N.

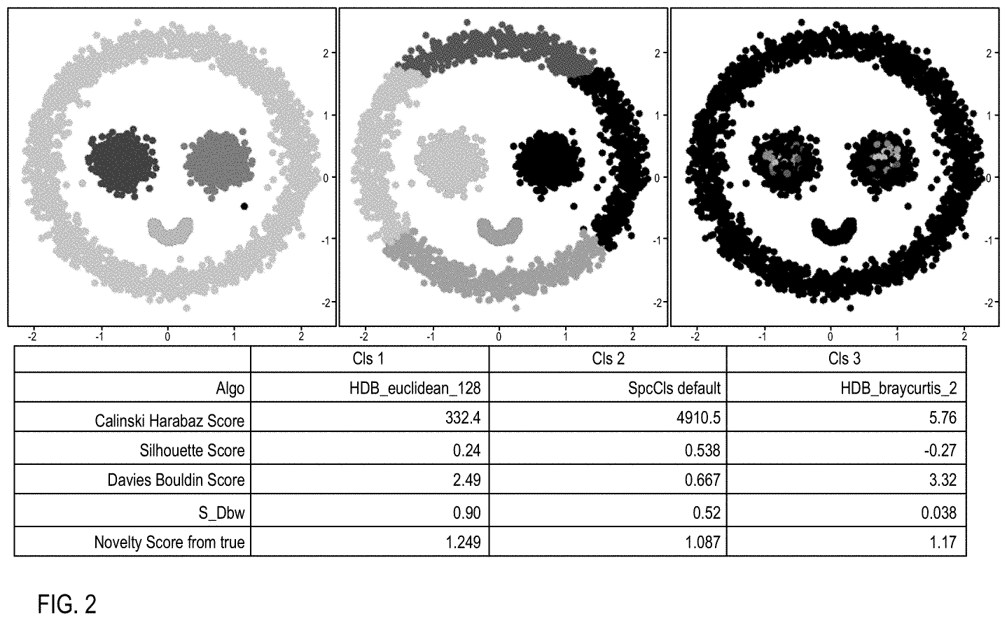

The diverse clustering module 114 then generates a report based on the second plurality of clustering models. In some embodiments, the report comprises one or more visualizations based on the second plurality of clustering models. For example, turning to FIG. 2, the report may indicate visualizations of the clustering reports, with variances in color, shading, or other attributes used to demark different clusters within a clustering model. For example, turning to FIG. 2, the example report shows visualizations for three different clustering models, as well as identifies the particular algorithms and cluster quality measurements for each clustering model (e.g., in the second plurality of clustering models). In the example report of FIG. 2, the leftmost visualization corresponds to the column Cls_1, the center visualization corresponds to column Cls 2, and the rightmost visualization corresponds to the column Cls_3. The row for each column indicates the particular classification algorithm used, as well as quality measurements in the form of a Calinski-Harabaz score, a Silhouette score, a Davies Baudin Score, a validity index S_Dbw, and a Novelty Score from true.

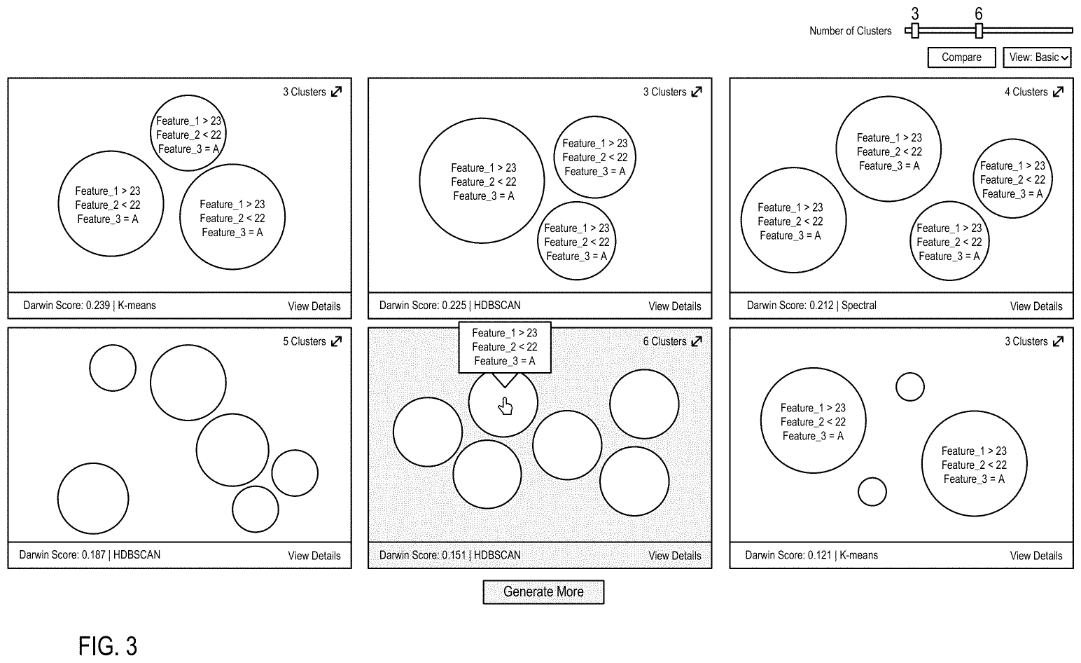

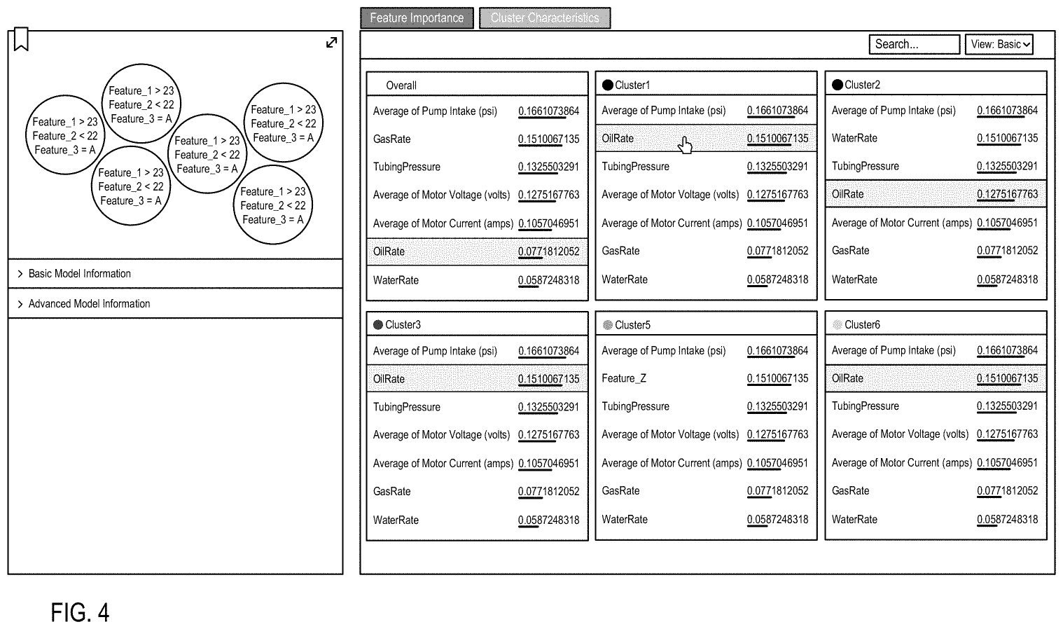

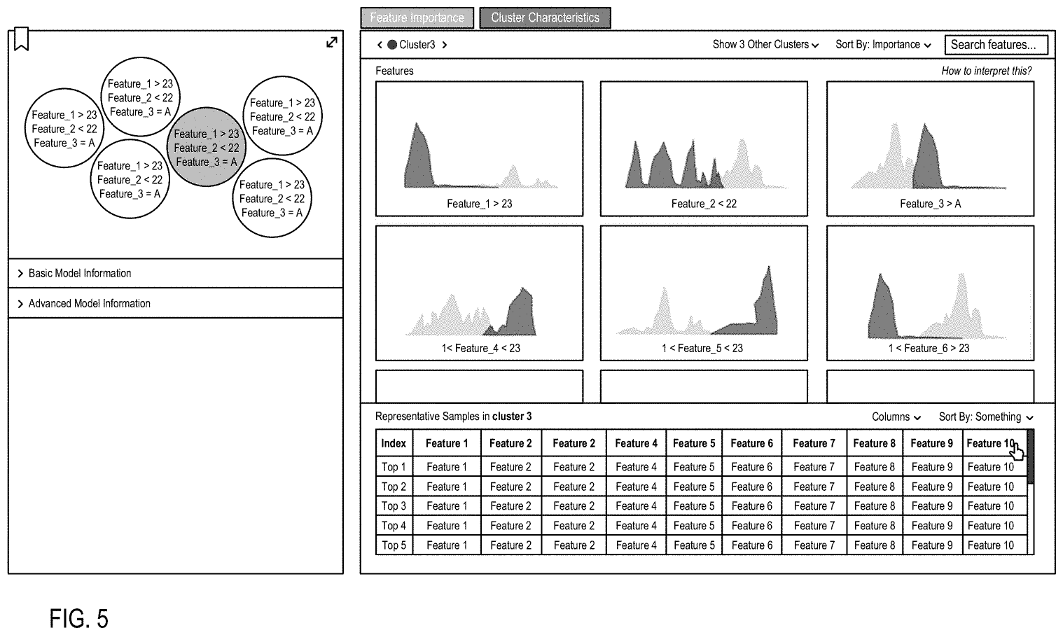

As another example, the report may include a user interface for exploring visualizations and data related to each clustering model in the second plurality of clustering models. For example, FIG. 3 shows a user interface with selectable user interface elements corresponding to each of the second plurality of clustering models. Selection of a particular clustering model may then show a detailed view related to that clustering model as shown in FIG. 4. The detailed view for a selected clustering module may show various attributes and data points related to the selected clustering model. The detailed view of a selected clustering module may also include selectable user interface elements for each cluster in the clustering model. A selection of a particular cluster will then bring up a detailed view for the cluster as shown in FIG. 5.

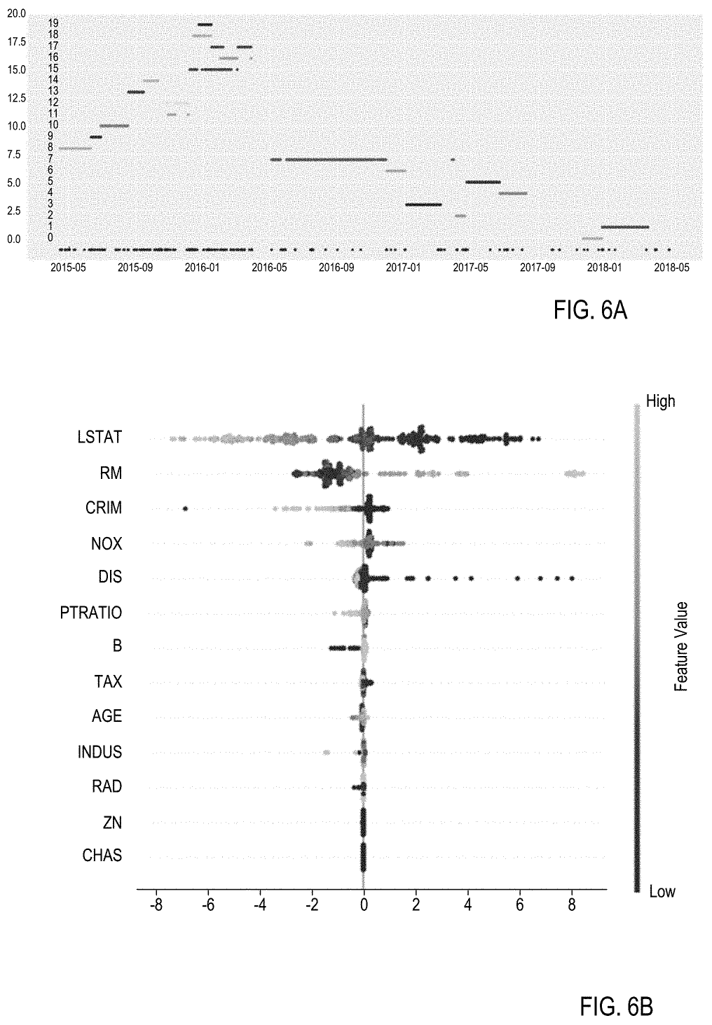

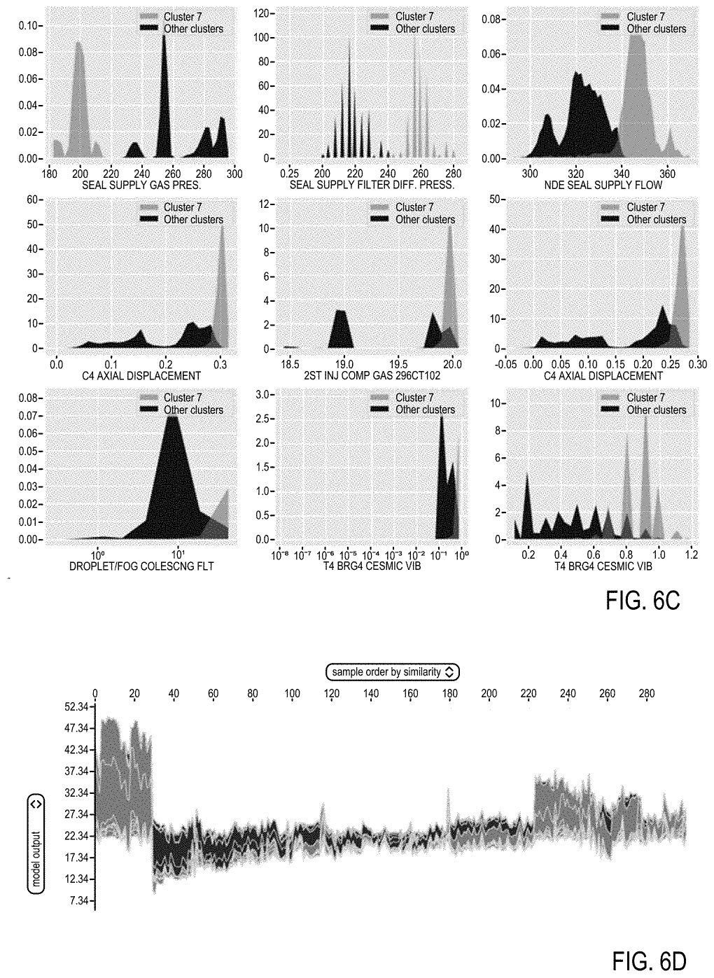

The generated report may include various graphs or visualizations known to one skilled in the art related to a particular cluster model, a particular cluster, or a particular data point. Such visualizations may include, for example, the cluster map of FIG. 6A, Shapely Additive Explanation (SHAP) plots of FIG. 6B or 6D, and/or a feature importance graph of FIG. 6C. Such visualizations may also include any other applicable visualizations as can be appreciated.

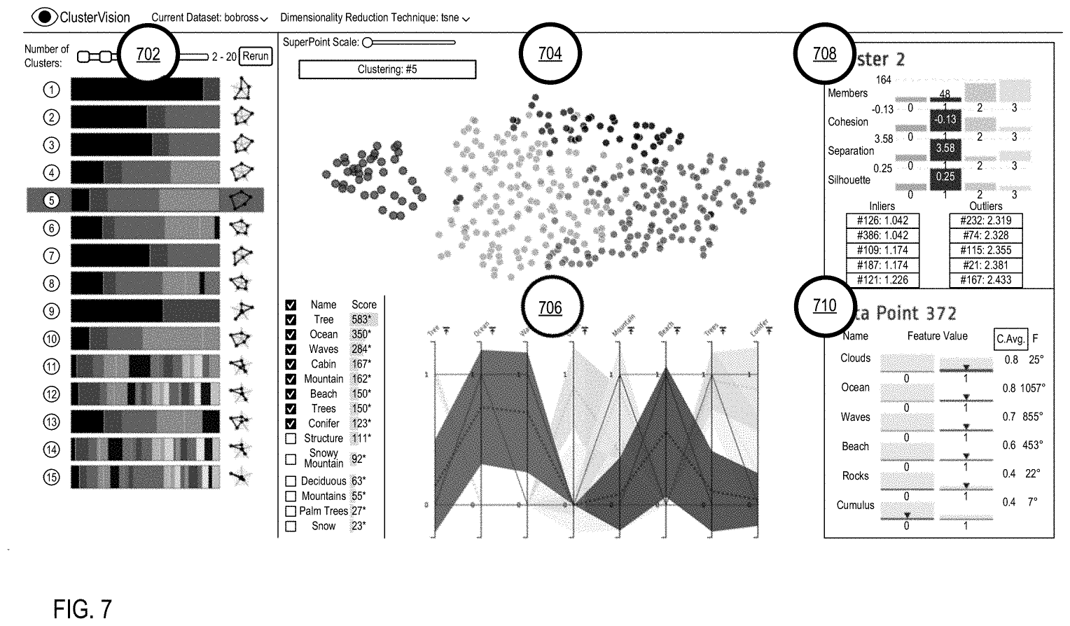

The generated report may include multiple graphs, visualizations, or selectable elements within a same user interface. For example, FIG. 7 shows a user interface with a list selection 702 for selecting a particular cluster model. In the illustrated example, clustering model number five is selected. The user interface also includes a cluster model visualization 704 depicting the generated clusters for the data set by the selected clustering model (e.g., clustering model number five). The cluster model visualization 704 allows for selection of a particular cluster from within the cluster model. The user interface also includes another cluster model visualization 706 where data points within the selected cluster are highlighted or otherwise emphasized for comparison. The user interface further includes a cluster metric display 708 displaying various metrics and cluster quality measurements related to the selected cluster. The user interface also includes a data point display 710 displaying the particular features and values of a selected data point.

One skilled in the art will appreciate that the approaches set forth herein for diverse clustering of a data set allow for a variety of clustering models to be generated from a same data set. Novel clustering models may then be automatically selected and represented in a report. The report allows for a user to explore the various attributes of the clustering models and the generated clusters, providing for a more detailed and varied view of data than would be available through generating a single clustering model. For example, FIGS. 3-7 illustrate aspects of a report, embodied as graphical user interfaces (GUIs), that can be used to explore clustering models generated from a data set, where such exploration can be done at various hierarchical levels (e.g., a clustering model level, a cluster level, and a data point level), and where various metrics and other information are presented to enable comparison and analysis at those levels.

Although the approaches set forth herein describe selecting novel clustering models (e.g., a second plurality of clustering models) from a superset of generated clustering models (e.g., a first plurality of clustering models), one skilled in the art will appreciate that, in alternative embodiments, the first plurality of clustering models may be imported from a data store or other encoding of clustering models. The second plurality of clustering models may then be selected from the imported clustering models.

Turning back to FIG. 1, the computer 100 of FIG. 1 includes disk drive adapter 116 coupled through expansion bus 118 and bus adapter 108 to processor 102 and other components of the computer 100. Disk drive adapter 116 connects non-volatile data storage to the computer 100 in the form of data storage 112. Disk drive adapters useful in computers configured for diverse clustering of a data set according to certain embodiments include Integrated Drive Electronics (‘IDE’) adapters, Small Computer System Interface (‘SCSI’) adapters, and others as will occur to those of skill in the art. In some embodiments, non-volatile computer memory is implemented as an optical disk drive, electrically erasable programmable read-only memory (so-called ‘EEPROM’ or ‘Flash’ memory), RAM drives, and so on, as will occur to those of skill in the art.

The example computer 100 of FIG. 1 includes one or more input/output (‘I/O’) adapters 120. I/O adapters implement user-oriented input/output through, for example, software drivers and computer hardware for controlling output to display devices such as computer display screens, as well as user input from user input devices 122 such as keyboards and mice. The example computer 100 of FIG. 1 includes a video adapter 124, which is an example of an I/O adapter specially designed for graphic output to a display device 126 such as a display screen or computer monitor. Video adapter 124 is connected to processor 102 through a high speed video bus 128, bus adapter 108, and the front side bus 130, which is also a high speed bus.

The exemplary computer 100 of FIG. 1 includes a communications adapter 132 for data communications with other computers and for data communications with a data communications network. Such data communications are carried out serially through RS-232 connections, through external buses such as a Universal Serial Bus (‘USB’), through data communications networks such as IP data communications networks, and/or in other ways as will occur to those of skill in the art. Communications adapters implement the hardware level of data communications through which one computer sends data communications to another computer, directly or through a data communications network. Examples of communications adapters useful in computers configured for diverse clustering of a data set according to certain embodiments include modems for wired dial-up communications, Ethernet (IEEE 802.3) adapters for wired data communications, and 802.11 adapters for wireless data communications.

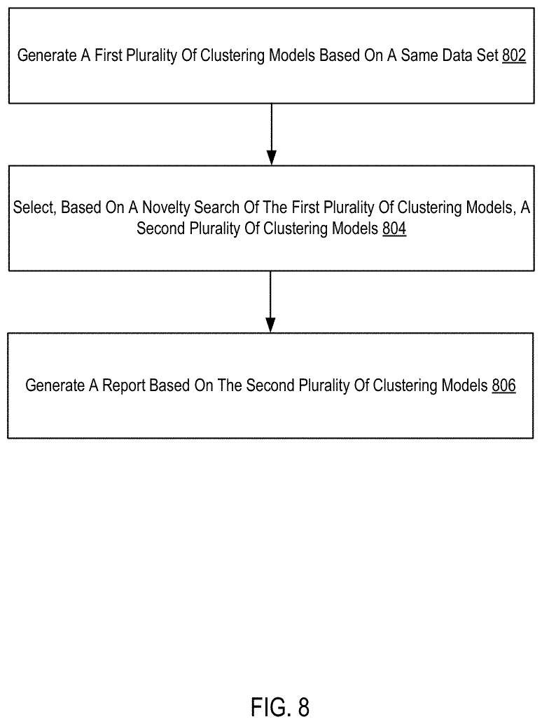

For further explanation, FIG. 8 sets forth a flow chart illustrating an example method for diverse clustering of a data set that includes generating 802 (e.g., by a diverse clustering module 114) a first plurality of clustering models based on a same data set. Each entry in the data set includes one or more values for one or more attributes (e.g., “features”). For example, where the data set is expressed as a table, each entry may correspond to a row while each feature may correspond to a column. Each clustering model of the first plurality of clustering models is a result of applying a given clustering algorithm to the data set using a particular set of hyperparameters. Thus, each of the first plurality of clustering models is different by virtue of being generated based on a different combination of an algorithm and hyperparameters relative to another clustering model. For example, two clustering models using the same clustering algorithm but different hyperparameter values would be considered different, two clustering models using different clustering algorithms but the same hyperparameter values would be considered different, and two clustering models using different clustering algorithms and hyperparameter values would also be considered different.

One skilled in the art will appreciate that the approaches described herein may be applied to any applicable clustering algorithm, including Hierarchical Density-Based Spatial Clustering of Applications with Noise (HDBSCAN), SpectralNet, and the like. The hyperparameters of the clustering algorithm describe various configurable attributes used by a given clustering algorithm independent of the actual values of the data set. For example, the hyperparameters may include a minimum number of clusters to be generated, a maximum number of clusters to be generated, or a specific number of clusters to be generated. In some embodiments, the number of clusters to be generated based on a list or range of numbers. For example, assuming the number of clusters to be generated is based on a list. In such an embodiment, each clustering algorithm may be applied to each permutation of hyperparameter values including each number in the list.

In some embodiments, the number of clusters to be generated (e.g., minimum, maximum, specific, or list) is defined based on a user input. In other embodiments, the number of clusters to be generated is dynamically calculated. For example, an algorithm to determine a best number of clusters may be applied to the data set, and the determined number is used as the number of clusters to be generated. As another example, the determined number may be used to generate a list of numbers of clusters. Continuing this example, for a determined number of clusters n_clusters, the list may be generated as [n_clusters/2, n_clusters, n_clusters*2], or by another approach as can be appreciated.

In some embodiments, the hyperparameters may include a distance measure to be used by the clustering algorithm. A distance measure is an algorithm or function to determine the distance between two points (e.g., entries) in the data set. For example, the distance measure may include a Euclidian distance function, a Manhattan distance function, a correlation distance function, or other distance function as can be appreciated. One skilled in the art will appreciate that the resulting clustering models generated from the same data set may vary based on the particular distance function used to generate the clusters of the clustering model.

In some embodiments, the hyperparameters may include a feature selection of the data set. A feature selection is a set of particular features of the data set to be used when generating the clustering model. Thus, a for a given feature selection that excludes one or more features of the data set, the excluded one or more features will not be considered when generating the clustering model. In some embodiments, the plurality of first clustering models may be generated using each possible combination of selected features. In some embodiments, the first plurality of clustering models may be generated such that each feature set combination used in generating the first plurality of clustering models always includes a particular feature. For example, given the retail customer example above, a user may specify that income range should always be included in any feature selection for which a clustering model is generated. In some embodiments, the first plurality of clustering models may be generated such that each feature set combination used in generating the first plurality of clustering models always excludes a particular feature. For example, given the retail customer example above, a user may specify that age should always be excluded in any feature selection for which a clustering model is generated. In some embodiments, the hyperparameters include whether or not principal component analysis (PCA) is applied to the data set prior to applying the clustering algorithm. By applying PCA, a subset of the features of the data set may be selected for application of the clustering algorithm.

The method of FIG. 8 also includes selecting 804, based on a novelty search of the first plurality of clustering models, a second plurality of clustering models. A novelty search of clustering models is a selection of N clustering models (e.g., the second plurality of clustering models) as a subset of M clustering models (e.g., the first plurality of clustering models), where the selection is based on a degree of difference between the M clustering models.

The novelty search may be performed using various metrics. The particular usage of such metrics and the particular clustering models upon which the measures will be calculated will be described in further detail below. In some embodiments, the metrics include a Rand index that quantitatively measures the similarity between two clustering models. In some embodiments, the metrics include a feature importance vector. A feature importance is quantitative measurement of the significance of a particular data set feature in generating a particular classification by a classifier model. Accordingly, a feature importance vector is a vector of feature importance values for each feature in the feature selection for the clustering model.

In some embodiments, calculating a feature importance vector for a given clustering model includes training a Random Forest classifier with the input data used to generate the clustering model (e.g., the selected feature data) and the clustering labels for the clustering model. The feature importance values for each feature in the selected feature is then calculated based on the Random Forest model. The resulting feature importance values are then included in the feature importance vector for the clustering model.

In some embodiments, the metrics include a novelty score. The novelty score is a quantitative evaluation of novelty between two clustering models. The novelty score for a pair of clustering models is based on the Rand index for the two clustering models and the feature importance vectors of each of the two clustering models. For example, in some embodiments, the novelty score NS may be calculated as NS=alpha*RI+cosine-similarity (FI1, FI2), where alpha is a free parameter, RI is the Rand index of the two clustering models, FI1 is the feature importance vector of a first clustering model, and FI2 is the feature importance vector of the second clustering model.

In some embodiments, the metrics include one or more cluster quality measurements. The cluster quality measurements for a given clustering model are quantitative evaluations of a degree of separation for clusters in the given clustering model, a degree of compactness for clusters in the given clustering model, or both. For example, in some embodiments, the cluster quality metrics include a Calinski-Harabasz score, a Silhouette score, or a Davies-Bouldin score. In other words, the one or more cluster quality metrics evaluate the topology of a given clustering model.

The method of FIG. 8 also includes generating 806 a report based on the second plurality of clustering models. In some embodiments, the report comprises one or more visualizations based on the second plurality of clustering models. For example, turning to FIG. 2, the report may indicate visualizations of the clustering reports, with variances in color, shading, or other attributes used to demark different clusters within a clustering model. For example, turning to FIG. 2, the example report shows visualizations for three different clustering models, as well as identifies the particular algorithms and cluster quality measurements for each clustering model (e.g., in the second plurality of clustering models).

As another example, the report may include a user interface for exploring visualizations and data related to each clustering model in the second plurality of clustering models. For example, FIG. 3 shows a user interface with selectable user interface elements corresponding to each of the second plurality of clustering models. Selection of a particular clustering model may then show a detailed view related to that clustering model as shown in FIG. 4. The detailed view for a selected clustering module may show various attributes and data points related to the selected clustering model. The detailed view of a selected clustering module may also include selectable user interface elements for each cluster in the clustering model. A selection of a particular cluster will then bring up a detailed view for the cluster as shown in FIG. 5.

The generated report may include various graphs or visualizations related to a particular cluster model, a particular cluster, or a particular data point. Such visualizations may include, for example, the cluster map of FIG. 6A, SHAP plots of FIG. 6B or 6D, or a feature importance graph of FIG. 6C.

The generated report may include multiple graphs, visualizations, or selectable elements within a same user interface. For example, FIG. 7 shows a user interface with a list selection 702 for selecting a particular cluster model. The user interface also includes a cluster model visualization 704 depicting the generated clusters for the data set. The cluster model visualization 704 allows for selection of a particular cluster from within the cluster model. The user interface also includes another cluster model visualization 706 where data points within the selected cluster are highlighted or otherwise emphasized for comparison. The user interface further includes a cluster metric display 708 displaying various metrics and cluster quality measurements related to the selected cluster. The user interface also includes a data point display 710 displaying the particular features and values of a selected data point.

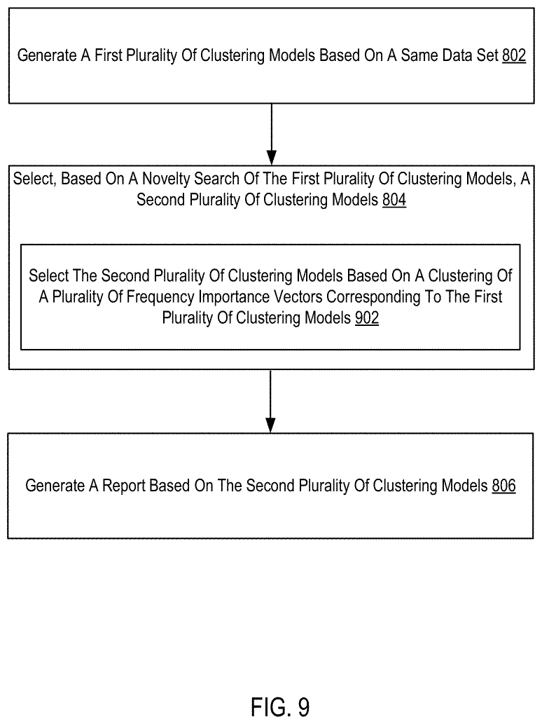

For further explanation, FIG. 9 sets forth a flow chart illustrating another example method for diverse clustering of a data set according to embodiments of the present disclosure. The method of FIG. 9 is similar to that of FIG. 8 in that the method of FIG. 9 also includes generating 802 a first plurality of clustering models based on a same data set; selecting 804, based on a novelty search of the first plurality of clustering models, a second plurality of clustering models; and generating 806 a report based on the second plurality of clustering models.

The method of FIG. 9 differs from FIG. 8 in that selecting 804, based on a novelty search of the first plurality of clustering models, a second plurality of clustering models includes selecting 902 the second plurality of clustering models based on a clustering of a plurality of feature importance vectors corresponding to the first plurality of clustering models. For example, a feature importance vector is calculated for each of the first plurality of clustering models. A KMeans algorithm is then applied to the feature importance vectors, where k=N (e.g., the number of clustering models to be included in the second plurality of clustering models). This results in N clusters of feature importance vectors. For each of the N feature importance vector clusters, a corresponding clustering model with highest a Calinski-Harabasz (or other cluster quality measurement) score is included in the second plurality of clustering models. Thus, the second plurality of clustering models includes a clustering model with a highest Calinski-Harabasz score relative to other clustering models in a same feature importance vector cluster.

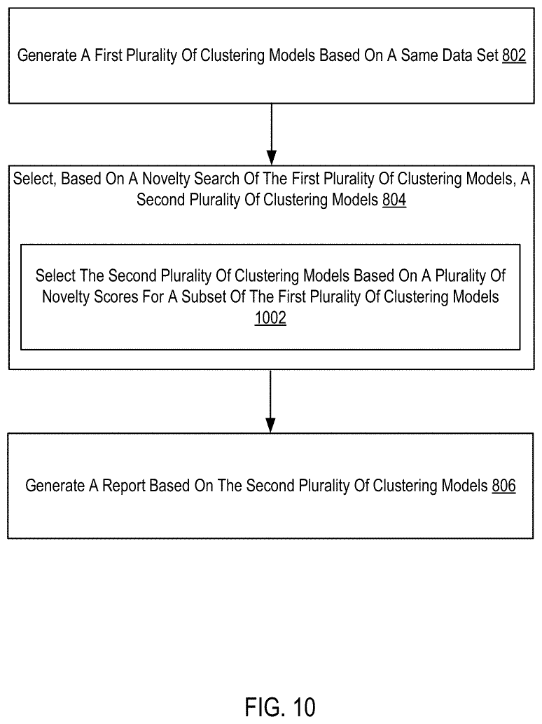

For further explanation, FIG. 10 sets forth a flow chart illustrating another example method for diverse clustering of a data set according to embodiments of the present disclosure. The method of FIG. 10 is similar to that of FIG. 8 in that the method of FIG. 10 also includes generating 802 a first plurality of clustering models based on a same data set; selecting 804, based on a novelty search of the first plurality of clustering models, a second plurality of clustering models; and generating 806 a report based on the second plurality of clustering models.

The method of FIG. 10 differs from FIG. 8 in that selecting 804, based on a novelty search of the first plurality of clustering models, a second plurality of clustering models includes selecting 1002 the second plurality of clustering models based on a plurality of novelty scores for a subset of the first plurality of clustering models. For example, in some embodiments, a Calinski-Harabasz (or other cluster quality measurement) score is calculated for each cluster model in the first plurality of clustering models. Where N is the number of clustering models to be included in the second plurality of clustering models, k clustering models are selected for inclusion in the second plurality of clustering models based on the ranking of the Calinski-Harabasz scores, where k=N/2. For example, clustering models at index (0, M/k, 2*M/k, . . . ) are added to the second plurality of clustering models, where M is the number of clustering models in the first plurality of clustering models.

For each of these selected clustering models (e.g., selected based on the Calinski-Harabasz scores), a novelty score is calculated relative to every other clustering model in the first plurality of clustering model (e.g., unselected clustering models). Thus, each novelty score is calculated relative to a selected clustering model and an unselected clustering model. For the top N/2 novelty scores, the corresponding unselected clustering model is then added to the second plurality of clustering models. Thus the second plurality of clustering models includes N/2 clustering models selected based on a Calinski-Harabasz score and another N/2 clustering models selected based on novelty scores.

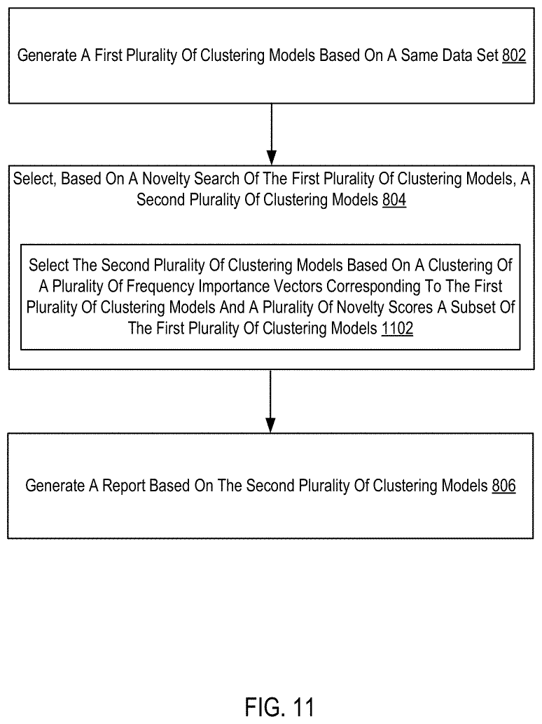

For further explanation, FIG. 11 sets forth a flow chart illustrating another example method for diverse clustering of a data set according to embodiments of the present disclosure. The method of FIG. 11 is similar to that of FIG. 8 in that the method of FIG. 11 also includes generating 802 a first plurality of clustering models based on a same data set; selecting 804, based on a novelty search of the first plurality of clustering models, a second plurality of clustering models; and generating 806 a report based on the second plurality of clustering models.

The method of FIG. 11 differs from FIG. 8 in that selecting 804, based on a novelty search of the first plurality of clustering models, a second plurality of clustering models includes selecting 1102 the second plurality of clustering models based on a clustering of a plurality of feature importance vectors corresponding to the first plurality of clustering models and a plurality of novelty scores for a subset of the first plurality of clustering models. As an example, in some embodiments, a feature importance vector is calculated for each of the first plurality of clustering models. A KMeans algorithm is then applied to the feature importance vectors, where k=N/2. This results in N/2 clusters of feature importance vectors. For each of the N/2 feature importance vector clusters, a corresponding clustering model with highest a Calinski-Harabasz (or other cluster quality measurement) score is selected for inclusion in the second plurality of clustering models.

For each of these selected clustering models (e.g., selected based on the feature importance vectors), a novelty score is calculated relative to every other clustering model in the first plurality of clustering model (e.g., unselected clustering models). Thus, each novelty score is calculated relative to a selected clustering model and an unselected clustering model. For the top N/2 novelty scores, the corresponding unselected clustering model is then added to the second plurality of clustering models. Thus the second plurality of clustering models includes N/2 clustering models selected based on feature importance vectors and another N/2 clustering models selected based on novelty scores.

In other embodiments, after running the KMeans (k=N/2) on the feature importance vectors, for a given feature importance vector cluster, a clustering model corresponding to a highest Calinski-Harabasz scoring feature importance vector is added to a list novelty_model_list. Novelty scores are then used to select a most novel clustering model from novelty_model_list using the geometric mean of the novelty distance. The selected clustering model is then added to a list novel_model_list. The process of selecting a most novel clustering model from novelty_model_list and adding it to novel_model_list is repeated until a size of the novel_model_list reaches N.

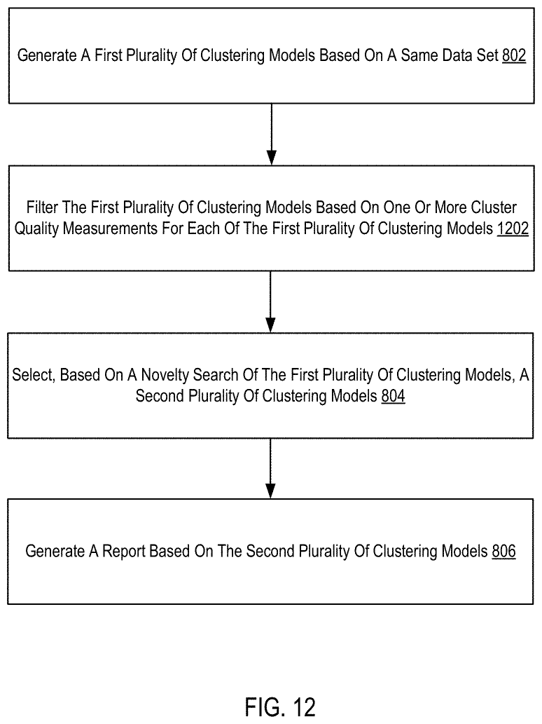

For further explanation, FIG. 12 sets forth a flow chart illustrating another example method for diverse clustering of a data set according to embodiments of the present disclosure. The method of FIG. 12 is similar to that of FIG. 8 in that the method of FIG. 12 also includes generating 802 a first plurality of clustering models based on a same data set; selecting 804, based on a novelty search of the first plurality of clustering models, a second plurality of clustering models; and generating 806 a report based on the second plurality of clustering models.

The method of FIG. 12 differs from FIG. 8 in that the method of FIG. 12 includes filtering 1202 the first plurality of clustering models based on one or more cluster quality measurements for each of the first plurality of clustering models. For example, clustering models having a particular cluster quality measurement above or below a threshold may be excluded from the first plurality of clustering models. As an example, clustering models with a Silhouette score below 0 may be filtered or removed from the first plurality of clustering models. This step removes noisy or unbalanced clustering models from consideration for inclusion in the second plurality of clustering models.

In view of the explanations set forth above, readers will recognize that the benefits of diverse clustering of a data set include:
Improved performance of a computing system by allowing for viewing and exploration of various cluster models generated for the same data set.

Exemplary embodiments of the present disclosure are described largely in the context of a fully functional computer system for diverse clustering of a data set. Readers of skill in the art will recognize, however, that the present disclosure also can be embodied in a computer program product disposed upon computer readable storage media for use with any suitable data processing system. Such computer readable storage media can be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present disclosure can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which includes one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes can be made in various embodiments of the present disclosure. The descriptions in this specification are for purposes of illustration only and are not to be construed in a limiting sense. The scope of the present disclosure is limited only by the language of the following claims.

What is claimed is:

1. A method of diverse clustering of a data set, the method comprising:
generating a first plurality of clustering models based on a same data set;
selecting, based on a novelty search of the first plurality of clustering models, a second plurality of clustering models; and
generating a report based on the second plurality of clustering models.

2. The method of claim 1, wherein the report comprises one or more visualizations for each of the plurality of clustering models.

3. The method of claim 1, wherein selecting the second plurality of clustering models comprises selecting the second plurality of clustering models based on a clustering of a plurality of feature importance vectors corresponding to the first plurality of clustering models.

4. The method of claim 1, wherein selecting the second plurality of clustering models comprises selecting the second plurality of clustering models based on a plurality of novelty scores for a subset of the first plurality of clustering models.

5. The method of claim 4, wherein each novelty score of the plurality of novelty scores is based on a Rand index for a particular pair of clustering models and a cosine similarity between the particular pair of clustering models.

6. The method of claim 1, wherein selecting the second plurality of clustering models comprises selecting the second plurality of clustering models based on a clustering of a plurality of feature importance vectors corresponding to the first plurality of clustering models and a plurality of novelty scores for a subset of the first plurality of clustering models.

7. The method of claim 1, wherein the first plurality of clustering models are each generated based on a different combination of an algorithm and one or more hyperparameters.

8. The method of claim 1, further comprising filtering the first plurality of clustering models based on one or more cluster quality measurements for each of the first plurality of clustering models.

9. The method of claim 1, wherein the report comprises one or more selectable elements that, when selected, cause one or more metrics or one or more quality measurements corresponding to a selected element to be displayed.

10. The method of claim 1, wherein the first plurality of clustering models each comprise a number of clusterings based on a user input or a selected from a calculated selection of numbers.

11. An apparatus for diverse clustering of a data set, the apparatus configured to perform steps comprising:
generating a first plurality of clustering models based on a same data set;
selecting, based on a novelty search of the first plurality of clustering models, a second plurality of clustering models; and
generating a report based on the second plurality of clustering models.

12. The apparatus of claim 11, wherein the report comprises one or more visualizations for each of the plurality of clustering models.

13. The apparatus of claim 11, wherein selecting the second plurality of clustering models comprises selecting the second plurality of clustering models based on a clustering of a plurality of feature importance vectors corresponding to the first plurality of clustering models.

14. The apparatus of claim 11, wherein selecting the second plurality of clustering models comprises selecting the second plurality of clustering models based on a plurality of novelty scores for a subset of the first plurality of clustering models.

15. The apparatus of claim 14, wherein each novelty score of the plurality of novelty scores is based on a Rand index for a particular pair of clustering models and a cosine similarity between the particular pair of clustering models.

16. The apparatus of claim 11, wherein selecting the second plurality of clustering models comprises selecting the second plurality of clustering models based on a clustering of a plurality of feature importance vectors corresponding to the first plurality of clustering models and a plurality of novelty scores for a subset of the first plurality of clustering models.

17. The apparatus of claim 11, wherein the first plurality of clustering models are each generated based on a different combination of an algorithm and one or more hyperparameters.

18. The apparatus of claim 11, wherein the steps further comprise filtering the first plurality of clustering models based on one or more cluster quality measurements for each of the first plurality of clustering models.

19. The apparatus of claim 11, wherein the report comprises one or more selectable elements that, when selected, cause one or more metrics or one or more quality measurements corresponding to a selected element to be displayed.

20. The apparatus of claim 11, wherein the first plurality of clustering models each comprise a number of clusterings based on a user input or a selected from a calculated selection of numbers.
